(19) United States
(12) Patent Application Publication
(10) Pub. No.: US 2026/0211463 A1
(43) Pub. Date: Jul. 23, 2026

(54) HINGE FOR ELECTRONIC DEVICE

(71) Applicant: Apple Inc., Cupertino, CA (US)

(72) Inventors: Joel Ravi, San Francisco, CA (US); Giancarlo A. Giustina, San Jose, CA (US); Paul Williams, Seattle, WA (US)

(21) Appl. No.: 19/278,735

(22) Filed: Jul. 23, 2025

Related U.S. Application Data
(60) Provisional application No. 63/746,510, filed on Jan. 17, 2025.

(51) Int. Cl. G06F 1/16; F16C 11/04

(52) U.S. Cl. CPC G06F 1/1681; F16C 11/04; G06F 1/163

(57) ABSTRACT

A wearable electronic device can include a frame, a display window coupled to the frame, and arm extending from the frame, and a compound hinge coupled to the arm and the frame. The hinge can include a first body coupled to the frame, a second body articulatably coupled to the first body and the second body coupled to the arm. The hinge can further include a third body coupled to the first body and the second body, a first hinge coupled to the first body and can move the arm relative to the frame in a first axis and a second hinge coupled to the second body and can rotate the arm relative to the frame in a second axis, a first hinge coupled to the first body, the arm configured to rotate relative to the frame about a first axis via the first hinge, and a second hinge coupled to the second body, the arm configured to rotate relative to the frame about a second axis via the second hinge.

### CROSS-REFERENCE TO RELATED APPLICATIONS

This application claims the benefit of U.S. Provisional Application No. 63/746,510, filed 17 Jan. 2025, entitled “HINGE FOR ELECTRONIC DEVICE,” the entire disclosure of which is hereby incorporated by reference.

### FIELD

The present disclosure relates generally to electronic devices. More particularly, the present disclosure relates to hinges for a wearable electronic device.

### BACKGROUND

Various head-mountable devices (HMDs) or wearable electronic devices can include securement arms or securement straps. HMDs that include securement straps can be adjusted such that users with different head sizes or shapes can customize the fit to increase comfort as the user dons the device. Current HMDs include securement arms that are not aesthetically pleasing or comfortable for a user to wear during normal everyday use. In addition, the degree of adjustability and functionality of these securement arms are limited such that not all head sizes and shapes are accommodated with a single SKU. For example, users cannot adjust traditional securement arm hinges, or the securement arms itself, to accommodate the varied sizes and shapes of a user's head (e.g., the height of a user's ears relative to the user's eyes and the width of a user's head). Therefore, there is a need for adjustable HMD securement arms and hinge mechanisms to accommodate varied sizes and shapes of a user's head.

### SUMMARY

In one example of the present disclosure, a wearable electronic device can include a frame, a display window coupled to the frame, an arm extending from the frame, and a compound hinge coupled to the arm and the frame. The hinge can include a first body coupled to the frame, a second body articulatably coupled to the first body and the second body also being coupled to the arm. The hinge can further include a third body coupled to the first body and the second body, a first hinge coupled to the first body can move the arm relative to the frame about a first axis, and a second hinge coupled to the second body can rotate the arm relative to the frame about a second axis.

In one example, the first body can define an internal volume. The third body can include a protrusion that can extend into the internal volume of the first body, can contact the first hinge, and can include an aperture defined by the third body. In one example, the first hinge can be a spring hinge, and the spring hinge can be coupled to the first body and can be in contact with the protrusion. In one example, the spring can include a compression spring. The spring can compress in response to a force on the protrusion by an arm moving relative to the frame in a first axis. In one example, the second hinge can include a friction hinge. The friction hinge can include a first washer in contact with the third body, a second washer in contact with the first washer, and a screw in contact with the second washer and disposed within the aperture of the third body. In one example, a rotation of the arm relative to the frame along a second axis increases friction between the first washer and the second washer to position the arm relative to the frame.

In one example of the present disclosure, a head-mountable display (HMD) can include a frame defining a first internal volume, a display window coupled to the frame, an arm movably coupled to the frame and defining a second internal volume, and a hinge assembly. The hinge assembly can include a first body within the first internal volume, a second body within the second internal volume, and a spring coupled to the first body and the second body. The hinge can further include a third body coupled to the first body, the third body defining a first slot, a fourth body coupled to the second body and defining a second slot, and a coupler in contact with the third body and the fourth body via respective slots.

In one example, the second body defines a channel, and a pin can be coupled to the first body portion such that the pin is articulatably coupled to the channel of the second body. In this way, the channel guides the pin such that a pivot point of the arm relative to the frame is positioned outside the first internal volume and the second internal volume. In one example, the coupler can define a first protrusion extending into the first slot and a second protrusion extending into the second slot. In this way, the arm moves relative to the frame via the hinge assembly, and the coupler can move relative to the first slot and the second slot as the arm moves relative to the frame. In one example, the spring can include a leaf spring.

In one example of the present disclosure, a wearable device can include a frame defining the first internal volume, a display window coupled to the frame, a securement arm extending from the frame, the securement arm defining a second internal volume, and a hinge assembly. The hinge assembly can include a cam disposed in the first internal volume and a shuttle disposed in the second internal volume. A proximal end of the shuttle can contact the cam.

In one example, the curvature of the cam surface can define a bi-stable hinge. In another example, the shuttle can include a spring.

### BRIEF DESCRIPTION OF THE DRAWINGS

The disclosure will be readily understood by the following detailed description in conjunction with the accompanying drawings, wherein like reference numerals designate like structural elements, and in which:

FIG. 1A illustrates a top view of a wearable electronic device;

FIG. 1B illustrates a top view of a wearable electronic device in a storage position;

FIG. 1C illustrates a top view of a wearable electronic device with arms in a first position;

FIG. 1D illustrates a top view of a wearable electronic device with arms in a second position;

FIG. 2A illustrates an isometric view of one example of a wearable electronic device;

FIG. 2B illustrates a perspective view of a compound hinge;

FIG. 2C illustrates a perspective view of a compound hinge in a first position;

FIG. 2D illustrates a perspective view of a compound hinge in a second position;

FIG. 2E illustrates an exploded view of a compound hinge;

FIG. 2F illustrates a perspective view of a compound hinge in a third position;

FIG. 2G illustrates a perspective view of a compound hinge in a fourth position;

FIG. 3 illustrates a cross-sectional view of one example of a hinge assembly;

FIG. 4A illustrates a perspective view of one example of a hinge assembly; and

FIG. 4B illustrates a cross-sectional view of one example of a hinge assembly.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The following disclosure relates to electronic devices. More particularly, the present disclosure relates to hinges for a wearable electronic device. Many head-mountable devices (HMD) or wearable electronic devices can include securement arms, straps, and/or bands that can be adjusted such that users with different head sizes or shapes can customize the fit to increase comfort when the user dons the device. In one example, the securement straps can wrap around and/or over the user's head. Current HMDs, including smart glasses, can include securement straps that are uncomfortable to wear through normal day to day operations (e.g., work or school) and adjustment systems can be bulky and aesthetically unappealing. However, the hinges and hinge assemblies for HMDs described herein provide user comfort, easy adjustability, and aesthetically pleasing designs for end users of various head shapes and sized.

In one example of the present disclosure, a wearable electronic device can include a frame, a display window coupled to the frame, an arm extending from the frame, and a compound hinge. The compound hinge can include a first body coupled to the frame, a second body articulatably coupled to the first body and coupled to the arm, and a third body coupled to the first body and the second body. The compound hinge can further include a first hinge coupled to the body that can move the arm relative to the frame in a first axis, and a second hinge coupled to the second body that can rotate the arm relative to the frame in a second axis. In this way, the compound hinge can allow for the hinge to be adjustable in a first axis and a second axis to accommodate a user's head size and shape.

In one example, the first hinge of the compound hinge can be a spring hinge, including a compression spring. In such an example, the spring can be compressed as the arm moves relative to the frame in the first axis. In this way, the spring hinge can enable the arms of the device to move outward (e.g., splay or away from the surface of the user's head) to accommodate different users' head widths as the user dons the device. When the user removes the device, the spring hinge can enable the arms to return to their original/resting position.

In one example, the second hinge of the compound hinge can be a friction hinge. The friction hinge can include a first washer in contact with the third body, a second washer in contact with the first washer, and a screw in contact with the second washer and disposed within the aperture of the third body. In this example, the rotation of the arm relative to the frame in a second axis can increase the friction between the first washer and the second washer such that friction can secure the arm remains in position. In this way, the arm position can be adjusted to accommodate to users' varying ear heights. This accommodation improves the users' optical positioning, which increases the visual comfort and immersive experience while the user dons the device.

In one example of the present disclosure, an HMD can include a frame defining a first internal volume, a display window coupled to the frame, an arm movably coupled to the frame and the arm defining a second internal volume, and a hinge assembly. The hinge assembly can include a first body housed within the first internal volume, a second body housed within the second internal volume, and a spring coupled to the first body and the second body. In one example, the spring can be a leaf spring. The hinge assembly can further include a third body coupled to the first body defining a first slot, a fourth body coupled to the second body defining a second slot, and a coupler in contact with the third and fourth body. In one example, the second body can define a channel. In this example, the first body can include a pin such that the pin can be articulatably coupled to the channel of the second body. In this way, the channel can guide the pin such that a pivot point of the arm relative to the frame of the HMD is positioned outside the first internal volume and the second internal volume. In this way, the hinge assembly can define a virtual pivot. A virtual pivot can create a pivot outside the housing of the device to control the folding position of the arms. The virtual pivot hinge design can increase the feel and feedback of the hinge as the user rotates the arm relative to the frame. In this example, the hinge can provide feedback as the arms of the HMD move from an opened position to a closed position.

In one example of the present disclosure, a wearable device can include a frame defining a first internal volume, a display window coupled to the frame, a securement arm extending from the frame and defining a second internal volume, and a hinge assembly. The hinge assembly can include a cam disposed in the first internal volume and a shuttle disposed in the second internal volume. A proximal end of the shuttle can contact the cam. In one example, the shuttle can include a spring. In another example, the curvature of the surface of the cam can define a bi-stable hinge. A bi-stable hinge can alternate the arm of the device between a stable closed position and a stable open position. The bi-stable hinge can provide feedback while the arm is opening and/or closing. The bi-stable hinge can further create stability when the arms are in an open or closed position such that arms can translate from the open to closed position or closed to open position when a force exceeding a threshold is applied to the arms by a user.

In these ways, the hinges and hinge assemblies of HMDs described herein provide adjustability and stable positioning of the securement arms. In addition, details regarding the various examples of hinges and hinge assemblies provide aesthetically pleasing arms, hinges, and devices.

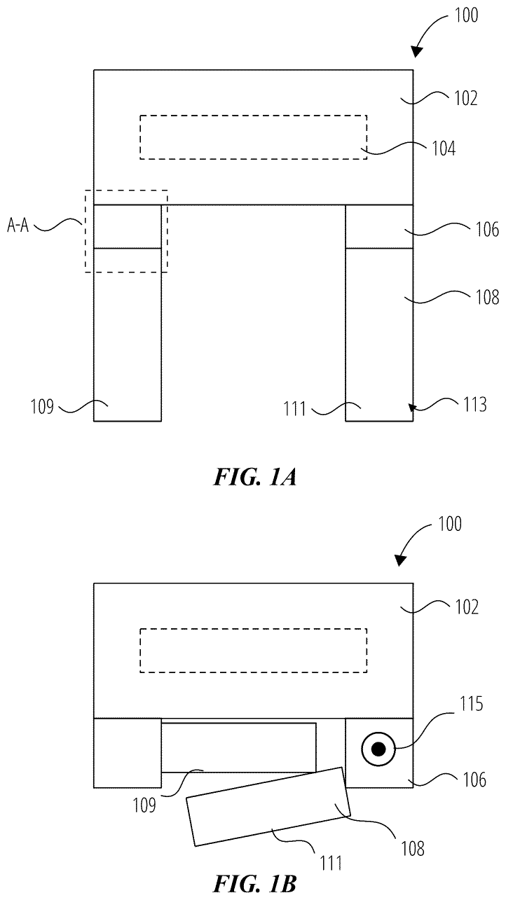

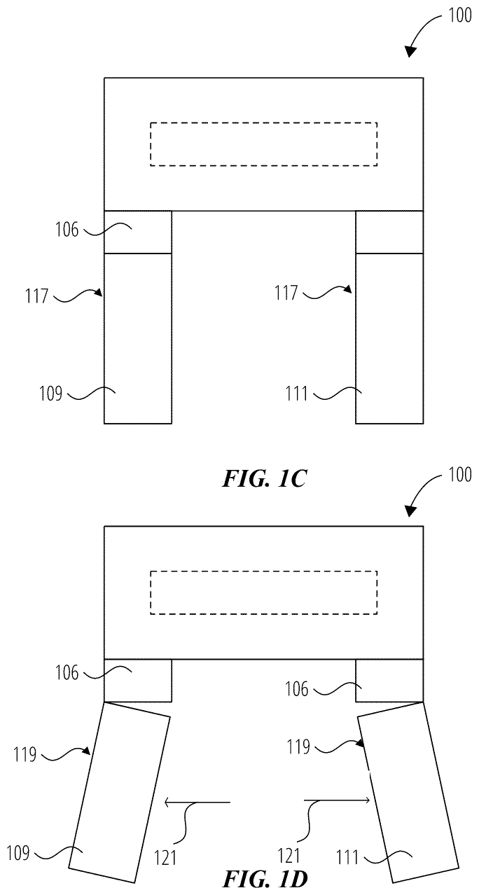

These and other embodiments are discussed below with reference to FIGS. 1-4B. However, those skilled in the art will readily appreciate that the detailed description given herein with respect to these figures is for explanatory purposes only and should not be construed as limiting. Furthermore, as used herein, a system, a method, an article, a component, a feature, or a sub-feature including at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIG. 1A illustrates a top view of a wearable display device 100. The wearable display device 100 can be a head-mountable device (HMD) or can be any device or system configured to be worn on the head of a user, such as an optical device, smart glasses, alternate/virtual reality goggles, and the like. As illustrated in FIG. 1, the wearable display device 100 can include at least one display frame 102, which can house a variety of component and systems. In one example, the display frame 102 can be configured to secure one or more display windows 104 configured to present visual information to the user. In one example of the present disclosure, the display windows 104 can include optically transparent display windows, display screens, transparent material, optical lenses, or transparent display screens, or combinations thereof, in front of the eyes of the user. The wearable display device 100 can include a hinge 106 coupled to the display frame 102. The wearable display device 100 can further include at least one arm or otherwise known as a securement arm 108. The securement arm 108 can movably couple to the hinge 106 and the securement arm 108 can be movable relative to the display frame 102 via the hinge 106. In this way, the securement arm 108 can be rotated or folded in (e.g., such as eyeglasses arms folded into a closed or storage position), as illustrated in FIG. 1B. FIG. 1B illustrates a top view of a wearable electronic device in a storage position. As illustrated in FIG. 1A and FIG. 1B, the wearable display device 100 can include two securement arms 108, but it should be understood the wearable display device 100 can include any suitable number of securement arms 108. In one example, the securement arms 108 can be arms extending from the display frame 102, a flexible band, overhead straps, or the like.

As illustrated in FIG. 1A, the wearable display device 100 can include a first securement arm 109 and a second securement arm 111. In one example, the first securement arm 109 and the second securement arm 111 can curve downward to comfortably fit behind the user's ears. In one example, the distal end 113 of the securement arm 108 can include a flexible material such that the user can adjust the curvature of the securement arm 108 to increase the comfort as the user dons the wearable display device 100. In this way, the wearable display device 100 can be donned by users with a variety of head sizes such that the wearable display device 100 can be comfortable for any suitable size or shape of head during use. As illustrated in FIG. 1A, a cut line A-A can be defined along the frame 102, the hinge 106, and the securement arm 108.

In one example, the securement arm 108 can define an internal volume and house a variety of different electrical components. These components can include a projector (not illustrated) disposed in the internal volume of the securement arm 108. The projector can be configured to direct light displayed at the display window 104 attached to the display frame 102. In another example, the components can include a battery, a microphone, an antenna, a processor, a speaker, or any other suitable electrical components. The electrical components can be disposed in the first securement arm 109, the second securement arm 111, both the first securement arm 109 and second securement arm 111, or any other suitable combination.

With reference to FIG. 1B, the securement arm 108 can rotate relative to the display frame 102 via the hinge 106 about a first axis 115, which is illustrated as extending perpendicularly out from the viewing plane of the drawing page/sheet. As illustrated in FIG. 1B, the first securement arm 109 and the second securement arm 111 can be rotated inward about the first axis 115 via the hinge 106. In this way, the first securement arm 109 and the second securement arm 111 can be positioned into a closed or storage position. In this way, the wearable display device 100 can be stored in a storage case with the securement arms 108 in a stow position. In this example, the first securement arm 109 and the second securement arm 111 can rotate outward from the position illustrated in FIG. 1B to the open position illustrated in FIG. 1A. In this way, in the open position of FIG. 1A, the user can don the wearable display device 100 on the user's head.

FIG. 1C illustrates a top view of the wearable display device 100. As illustrated in FIG. 1C, the first securement arm 109 and the second securement arm 111 can be in a first position 117. In one example, the first position 117 can be an open position for a user to don the wearable display device 100.

FIG. 1D illustrates a top view of the wearable display device 100. As illustrate in FIG. 1D, the first securement arm 109 and the second securement arm 111 can be in a second position 119. In one example, this second position shown can be a splayed position to accommodate wider heads. In this example, the first securement arm 109 and the second securement arm 111 can independently pivot from the first position 117 to the second position 119 as a force 121 is exerted on the first securement arm 109 and the second securement arm 111. In one example, the force 121 exerted or applied to the first securement arm 109 and the second securement arm 111 can be the head (e.g., the temple) of the user as the user dons the wearable display device 100. In this example, the hinges 106 of the wearable display device 100 can enable the first securement arm 109 and the second securement arm 111 to translate from the first position 117 to the second position 119. As discussed in more detail below, the hinges 106 of the wearable display device 100 can enable to the first securement arm 109 and the second securement arm 111 to rotate past the first position 117 to splay outward to widen the space between the first securement arm 109 and the second securement arm 111, thus accommodating different sizes of heads, including wider heads. The hinges 106 disclosed herein can increase the comfort to any width of head of a user that dons the wearable display device 100.

In another example, the hinges 106 disclosed herein can prevent damage to the first securement arm 109, the second securement arm 111, the hinges 106, and/or the display frame 102 as the first securement arm 109 and the second securement arm 111 are able to rotate past the first position 117 and prevent the first securement arm 109 or the second securement arm 111 from breaking or forcibly separating from the hinges 106 if an unexpected force 121 is exerted on the arms 109, 111.

Any of the features, components, and/or parts, of the electronic device, including the arrangements and configurations thereof shown in FIG. 1A-FIG. 1D, can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 1A-FIG. 1D.

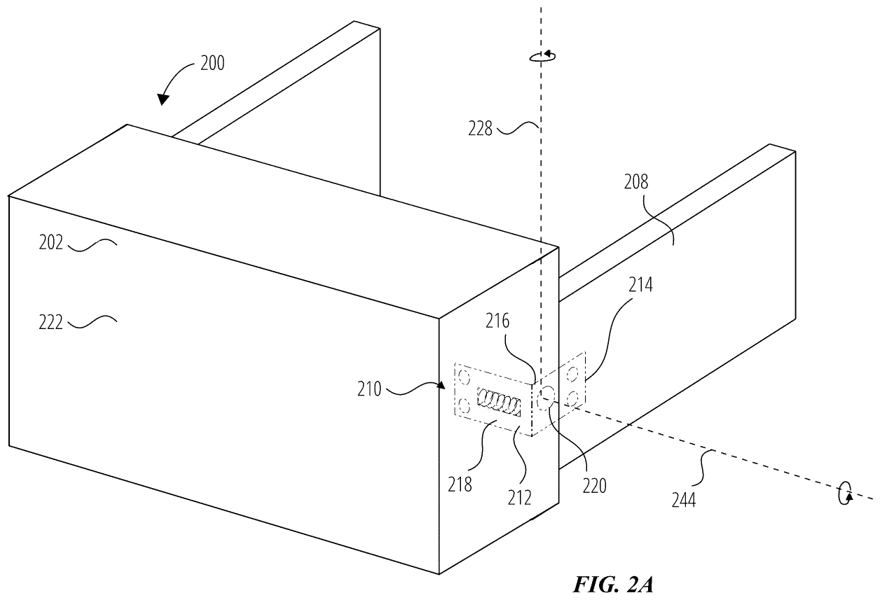

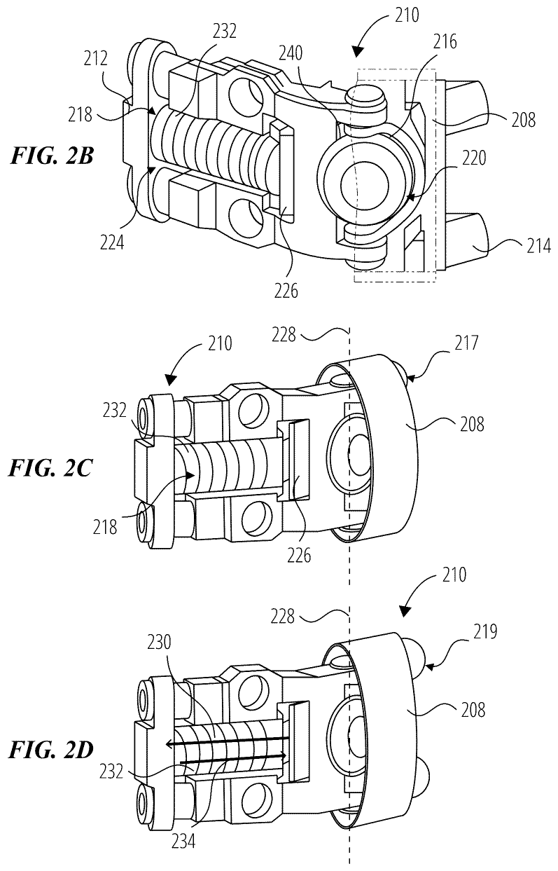

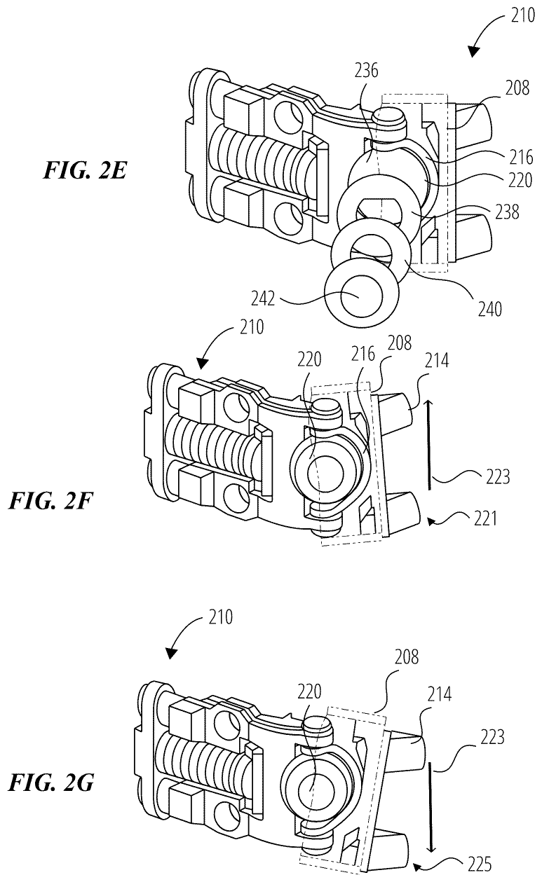

FIG. 2A through FIG. 4B illustrate examples of a wearable display device, which can resemble the wearable display device 100 described above in FIG. 1A through FIG. 1D in certain respects. For example, FIG. 2A includes a wearable electronic device 200 that can include similar features of the wearable display device 100 of FIG. 1A. Relevant disclosure set forth above regarding similarly identified features thus may not be repeated hereafter. Moreover, specific features of the wearable display device and related components of FIG. 1A through FIG. 1D may not be shown or identified by reference numeral in the drawings or specifically discussed in the written description that follows. However, such features may clearly be the same, or substantially the same, as features depicted in other embodiments and/or described with respect to such embodiments. Accordingly, the relevant descriptions of such features apply equally to the features of the wearable display device, HMD, and related components depicted in FIG. 2A through FIG. 4B.

FIG. 2A illustrates an isometric view of one example of a wearable electronic device 200. The wearable electronic device 200 can include a frame 202 and a display window 222 coupled to the frame 202. The wearable electronic device 200 can further include an arm 208 extending from the frame 202 and a compound hinge 210 coupled to the arm 208 and the frame 202. In one example, the compound hinge 210 can include a first body 212 coupled to the frame 202, a second body 214 articulatably coupled to the first body 212 and coupled to the arm 208, and a third body 216 coupled to the first body 212 and the second body 214. In one example, the compound hinge 210 can be configured such that the arm 208 extending from the frame 202 can rotate into a storage position as illustrated in FIG. 1B. As discussed in more detail below, the compound hinge 210 can be configured such that the arm 208 can translate outward into a widened, splayed position, such as the second position 119 illustrated in FIG. 1D. In this example, the compound hinge 210 can include a first hinge 218 coupled to the first body 212 and a second hinge 220 coupled to the second body 214.

FIG. 2B illustrates a perspective view of a compound hinge 210. The compound hinge 210 can include the first hinge 218 coupled to the first body 212 and the second hinge 220 coupled to the second body 214. FIG. 2B illustrates a portion of the arm 208 in dotted lines. The dotted lines indicate transparency for illustrating internally disposed components of the compound hinge 210. The portion of the arm 208 is illustrated in FIG. 2B to show how the compound hinge can fit within the internal volumes of the frame 202 and the arm 208. The same or similar portion of the arm 208 is illustrated in FIGS. 2C and 2D, where the arm 208 is not transparent. FIGS. 2E and 2F show the arm as transparent.

As illustrated in FIG. 2B, the first hinge 218 can include a spring hinge. In one example, the spring hinge can include a spring 232 and the spring 232 can be a compression spring. In one example, the first body 212 can define an internal volume 224. In this example, the third body 216 can include a protrusion 226 that can extend into the internal volume 224 of the first body 212 and contacting the first hinge 218. As illustrated in FIG. 2A, the protrusion 226 of the third body 216 can be in contact with the first hinge 218 or the spring hinge.

In one example, the spring 232 of the spring hinge can be compressed in a response to a force from the protrusion 226. The arm 208 moving relative to the frame 202 (e.g., moving from a first position 117 position of FIG. 1C to the second position 119 position of FIG. 1D) can move the second body 214 relative to the frame as the second body 214 is coupled to the arm 208. In this example, as the second body 214 translates with the arm 208 and the second body 214 can move the third body 216 such that the protrusion 226 in contact with the first hinge 218 can compress the spring 232 by the force provided by the protrusion 226.

In this example, as a user with a head wider than a distance of the arms in the first position shown in FIGS. 1A, 1C, and 2A, the arm 208 (e.g., the first securement arm 109 and the second securement arm 111 of FIG. 1C and FIG. 1D) can splay outward into a wider position, such as the second position 119 illustrated in FIG. 1D to accommodate to the wide head. The spring hinge (e.g., the first hinge 218) spring 232 can be in a compressed state as the user dons the wearable electronic device 200. When the user removes the wearable electronic device 200 the compression spring 232 can expend a force on the protrusion 226 such that the arm 208 can return to the open shape (e.g., the first position 117 of FIG. 1C). In this way, the first hinge 218 of the compound hinge 210 can accommodate users with various head widths to ensure a comfortable experience.

FIG. 2C illustrates a perspective view of the compound hinge 210. The compound hinge 210 illustrated in FIG. 2C can be in an open position or a first position 217, such as the first position 117 illustrated in FIG. 1C. In this way, the first hinge 218 can move or rotate the arm 208 relative to the frame 202 about a first axis 228, as shown in FIG. 2A. As illustrated in FIG. 2C, the protrusion 226 can be in contact with the first hinge 218 but not applying a force, as the arm 208 is not moving relative to the frame 202.

FIG. 2D illustrates a perspective view of the compound hinge 210. As illustrated in FIG. 2D, the compound hinge 210 can be in a second position 219, such as the second position 119 illustrated in FIG. 1D. In this example, the user can don the wearable electronic device 200 and translate the arm 208 and the compound hinge 210 such that the arm 208 can rotate relative to the frame 202 about the first axis 228 and translate from the first position 217 to the second position 219. As illustrated in FIG. 2D, the protrusion 226 is in contact with the first hinge 218 and as the arm 208 rotates about the first axis 228 and the protrusion 226 exerts a force 230 on the first hinge 218.

As illustrated in FIG. 2D, the arm 208 can rotate about the first axis 228 to accommodate to the width of a user's head. In one example, the arm 208 can rotate about the first axis 228 in a range from 0° to 45°. In one example the arm 208 can rotate about the first axis 228 in a range from 0° to 15°. For example, the arm 208 can rotate about the first axis 228 11° as to accommodate a user's head width. In this way, the spring 232 of the first hinge 218 can be compressed by the protrusion 226 such that the arm 208 can rotate about the first axis 228 into the second position 119. In this example, the first hinge 218 of the compound hinge 210 can accommodate a variety of user head widths to increase the comfort to the user as the user dons the wearable electronic device 200. As discussed above, as the user removes the wearable electronic device 200, the spring 232 can exert a second force 234 on the protrusion 226 as to remove the arm 208 to the first position 217 as illustrated in FIG. 2C. The example illustrated in FIG. 2D should be a non-limiting example. In this way, the arm 208 can rotate about the first axis 228 from 0° to 45° as to accommodate any user's head width. As illustrated in FIGS. 2C and 2D, the arm 208 component can illustrate the compound hinge 210 disposed within an internal volume defined by the display frame 202 and the arm 208.

FIG. 2E illustrates an exploded view of a compound hinge 210. As illustrated in in FIG. 2E, the third body 216 can include an aperture 236 defined by the third body 216. In one example, the second hinge 220 can include a friction hinge. In this example, the friction hinge or the second hinge 220 can include a first washer 238 that can be in contact with the third body 216. In one example, the first washer 238 can include a friction washer such that the friction washer can be in contact with the third body 216. In this example, the friction hinge can further include a second washer 240 in contact with the first washer 238. In this way, the second washer 240 can be a Belleville washer. A Belleville washer can be a spring shaped washer in the shape of a cone frustum that gives the washer the spring characteristics. Furthermore, the friction hinge can include a screw 242 in contact with the second washer 240 and disposed within the aperture 236 of the third body 216.

In this way, the screw 242 can be fastened into the aperture 236 such that the screw 242, the first washer 238, and the second washer 240 are in contact with each other. The first washer 238 can interact with the surface of the third body 216 and the surface of the second washer 240 such as to increase the friction therebetween. As illustrated in FIG. 2E, the arm 208 can be in a first position, such as the first position 117 as illustrated in FIG. 1C. In this way the friction between the first washer 238 and the second washer 240 can be at an initial state, such that the friction at this state can be the lowest between the first washer 238, the second washer 240, and the third body 216. As illustrated in FIG. 2E, the second body 214 can be at neutral position relative to a second axis 244, such as the second axis 244 as illustrated in FIGS. 2A and 2C.

FIG. 2F illustrates a perspective view of the compound hinge 210. As illustrated in FIG. 2F, the compound hinge 210 can be in a third position 221. In the third position 221, the second hinge 220 can be configured to rotate the second body 214 and the arm 208 relative to the frame 202 about the second axis 244. In one example, the second body 214 can be rotated up and down about the second axis 244 in a range of 15° to −15°. In one example, the second body 214 can rotate about the second axis 244 in a range of 0° to 10°. For example, the second body 214 can rotate about the second axis 244 8.5° such as to accommodate to a user's ear height. In this example, as the arm 208 rotates relative to the frame 202 in the second axis 244 via the second hinge 220, the friction between the surface of the third body 216, the first washer 238, and the second washer 240 increases such that the arm 208 and the second body 214 can be held in the third position 221 relative to the frame 202. In this example, a force 223 can be applied by the user to the arm 208 or the second body 214 to rotate the arm 208 and the second body 214 about the second axis 244 to raise the distal end, such as the distal end 113 of the securement arm 108 as illustrated in FIG. 1, of the arm 208 relative to the frame 202. Thereby, the arm 208 can be angled upward from the compound hinge 210 such that the distal end of the arm 208 can be higher than the compound hinge 210, for example 8.5° higher, as illustrated in FIG. 2F. User's ear heights relative to their eyes can vary from user to user. The second hinge 220 shown in FIGS. 2A-2G can enable an adjustment of the arm 208 of the wearable electronic device 200 such that the arm 208 can be angled to the user's ear height to align the display window directly in front of the user's eyes. In this example, the user's ears can be in a higher position relative to the user's eyes. Therefore, the arm 208 can be adjusted via the second hinge 220 of the compound hinge 210 to accommodate for the relative distance in height between the eyes and ears to deliver an immersive and comfortable experience. The example discussed above and illustrated in FIG. 2F is a non-limiting example.

FIG. 2G illustrates a perspective view of the compound hinge 210. As illustrated in FIG. 2G, the compound hinge 210 can be in a fourth position 225. In the fourth position 225, the second hinge 220 can be configured to rotate the second body 214 and the arm 208 relative to the frame 202 about the second axis 244. As annotated and illustrated in FIG. 2G, the second body 214 can be rotated about the second axis 244 in an angle range of 15° to −15°. In one example, the second body 214 can be rotated about the second axis 244 in a range of 0° to −10°. For example, the second body 214 can be rotated about the second axis 244 −8.5° to accommodate a user's ear height. In this example, as the arm 208 rotates relative to the frame 202 in the second axis 244 via the second hinge 220, the friction between the surface of the third body 216, the first washer 238, and the second washer 240 increases such that the arm 208 and the second body 214 can be held in the fourth position 225 relative to the frame 202. In this example, a force 223 can be applied by the user to the arm 208 or the second body 214 to rotate the arm 208 and the second body 214 about the second axis 244 as to raise the distal end, such as the distal end 113 of the securement arm 108 as illustrated in FIG. 1, of the arm 208 relative to the frame 202. Thereby, the arm 208 can be angled downward from the compound hinge 210 such that the distal end of the arm 208 can be lower than the compound hinge 210, as illustrated in FIG. 2G. Therefore, the arm 208 can be adjusted via the second hinge 220 of the compound hinge 210 as to accommodate for the ears of the user that lay below the eyes of the user to deliver an immersive and comfortable experience. The example discussed above and illustrated in FIG. 2F, should be a non-limiting example.

Any of the features, components, and/or parts, of the electronic device, including the arrangements and configurations thereof shown in FIG. 2A-FIG. 2G, can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 2A-FIG. 2G.

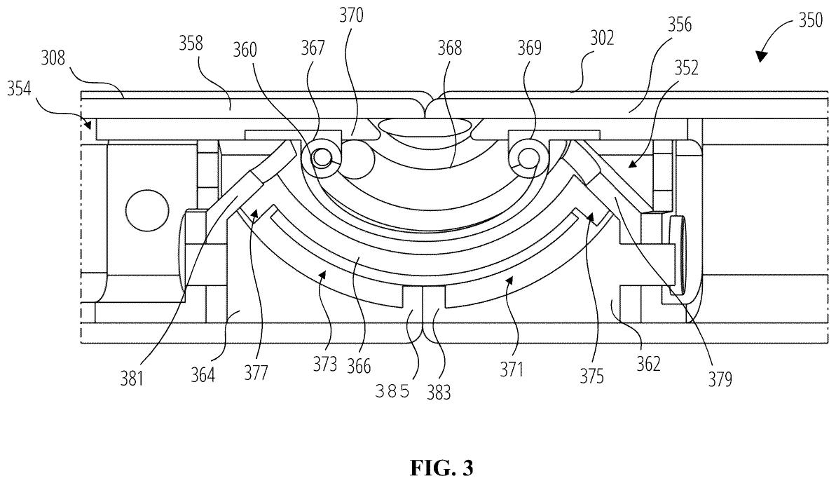

FIG. 3 illustrates a cross-sectional view of one example of a hinge assembly 350 along the cut line A-A illustrated in FIG. 1A. In one example, the HMD or wearable display device, such as the wearable display device 100 of FIG. 1A, can include a frame 302 defining a first internal volume 352, a display window (not illustrated), such as the display window 104 as illustrated in FIG. 1C. In this example, the HMD can include an arm 308 movably coupled to the frame 302 that can move relative to the frame 302 via the hinge assembly 350, and the arm 308 can define a second internal volume 354. In this example, the HMD can include the hinge assembly 350. In one example, the hinge assembly 350 can include a first body 356 housed within the first internal volume 352, a second body 358 housed within the second internal volume 354, and a spring 360 coupled to the first body 356 and the second body 358. In one example, the spring 360 can include a leaf spring. As illustrated in FIG. 3, the first body 356 can include a first fastener 367 and the second body 358 can include a second fastener 369. In such an example, the spring 360, for example the leaf spring, can be secured to the first body 356 and the second body 358 via the first fastener 367 and the second fastener 369. The first fastener 367 and the second fastener 369 can include a bolt, a pin, or any other suitable fastener.

As illustrated in FIG. 3, the first body 356 can include a pin 370 coupled to the first body 356 and the second body 358 can define a channel 368. In one example, the pin 370 can be articulatably coupled to the channel 368 of the second body 358. In this example, the pin 370 can extend through the channel 368 to be guided by the channel 368. In one example, the channel 368 can limit the movement of the pin 370 as the arm 308 rotates from an open position, as illustrated in FIG. 1A, to a closed position, as illustrated in FIG. 1B. In this way, the channel 368 can guide the pin 370 such that a pivot point relative to the frame 302 is positioned outside the first internal volume 352 and the second internal volume 354. In this example, the pin 370 in the channel 368 can provide force feedback to the user as the pin 370 movement can be stopped by the channel 368, alerting the user the arm 308 is in the open or close position.

In one example, the hinge assembly 350 can further include a third body 362 coupled to the first body 356 and can define a first slot 371 or recess, and a fourth body 364 coupled to the second body 358 and can define a second slot 373 or recess. In one example, the hinge assembly 350 can further include a coupler 366 in contact with the third body 362 and the fourth body 364. As illustrated in FIG. 3, the coupler 366 can a first protrusion 375 extending into the first slot 371, and a second protrusion 377 extending into the second slot 373. In this example, the coupler 366 can be configured to move relative to the first slot 371 and the second slot 373 as the arm 208 moves relative to the frame 302. As illustrated in FIG. 3, the first slot 371 and the second slot 373 can be designed such as to restrict the movement of the first protrusion 375 and the second protrusion 377 of the coupler 366. Thereby, the hinge assembly 350 can be a virtual pivot hinge.

As illustrated in FIG. 3, the arm 308 of the HMD is in an open position, such as the first position 117 illustrated in FIG. 1C, and first protrusion 375 can be in contact with a first wall 379 defined by the first slot 371, and the second protrusion 377 can be in contact with a second wall 381 defined by the second slot 373. In this way, the first wall 379 and the second wall 381 can restrict the movement of the coupler 366 such that the hinge assembly 350 cannot be rotated past this open position. In this example, the spring 360 can provide forces to keep the arm 308 in an open position so the spring 360 provides a force such that the first wall 379 and the second wall 381 stay connected with the first protrusion 375 and the second protrusion 377.

In one example, the arm 308 can be rotated into a closed position, as illustrated in FIG. 1B. In this way, the spring 360 can be compressed as the arm 308 rotates relative to the frame 302 and the coupler 366 can move relative to the first slot 371 and the second slot 373. In this example, the arm 308 rotating into a closed position can provide feedback to the user as the first protrusion 375 can travel and contact a third wall 383 and the second protrusion 377 can travel and contact a fourth wall 385. Thereby, the third wall 383 and the fourth wall 385 can restrict the movement of the arm 308 rotating to the closed position and provide feedback to the user. Furthermore, the spring 360 can be in a compressed position so as to keep the arm 308 in a closed position. In one example, as the user exerts a force to overcome the spring 360 force to open the arm 308, the spring 360 can spring the arm 308 into the open position. In this example, the hinge assembly 350 can be a bi-stable hinge. As discussed above, the bi-stable hinge can provide strong feedback while the arm is opening and/or closing. The bi-stable hinge can further create stability when the arm 308 is in an open or closed position such that arm 308 can translate from the open to closed position or closed to open position when a force exceeding a threshold is applied to the arm 308 by a user.

In one example, the hinge assembly 350 can include the components and features of the examples discussed above. In this example, the hinge assembly 350 does not have a spring 360, and the pin 370 surface and the channel 368 surface can be treated (e.g., textured powder, abrasion, or any other suitable method) to increase the coefficient of friction of the pin 370 surface and the channel 368 surface. In this way, the friction created between the pin 370 and the channel 368 as the pin 370 travels through the channel 368 can provide feedback to the user and slow the movement of the arm 308 as the arm 308 rotates relative to the arm 308.

Any of the features, components, and/or parts, of the electronic device, including the arrangements and configurations thereof shown in FIG. 3, can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 3.

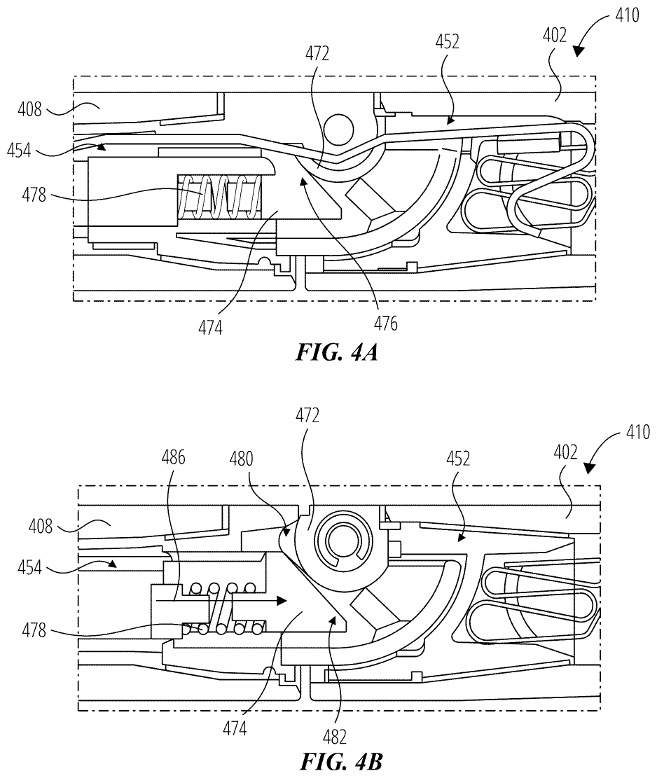

FIG. 4A illustrates a perspective view of a hinge assembly 410 that can be a part of a wearable device, such as the wearable display device 100 as illustrated in FIG. 1A. In one example, the wearable device can include a frame 402 defining a first internal volume 452, a display window (not illustrated) coupled to the frame, and a securement arm 408 extending from the frame 402 and defining a second internal volume 454. The hinge assembly 410 can include a cam 472 disposed in the first internal volume 452 and a shuttle 474 disposed in the second internal volume 454. As illustrated in FIG. 4A, a proximal end 476 of the shuttle 474 can contact the cam 472. As illustrated in FIG. 4A, the shuttle 474 can include a spring 478. In one example, the spring 478 can include a compression spring or any other suitable spring.

FIG. 4B illustrates a cross-sectional view of the hinge assembly 410 along the cut line A-A illustrated in FIG. 1A. As illustrated in FIG. 4B, the cam 472 can define a distal end 480 such that the curvature of the distal end 480 of the cam 472 surface can define a bi-stable hinge. In this way, the distal end 480 of the cam 472 can be in contact with a proximal end 482 of the shuttle 474. As illustrated in FIG. 4B, the proximal end 482 of the shuttle 474 can be defined as a slanted end. In this example, as the securement arm 408 of the wearable device rotates from the open position as illustrated in FIG. 4A and FIG. 4B, such as the open arm position illustrated in FIG. 1A, to a closed position, such as illustrated in FIG. 1B, the distal end 480 of the cam 472 traverses up the slant defined by the shuttle 474 and the spring 478 begins to compress. Thereby, as the distal end 480 of the cam 472 reaches the top of the slant of the shuttle 474, the spring 478 is in its most compressed state. At this point, the securement arm 408 can be in the closed position.

In one example, the user can exert a force as to open rotate the securement arm 408 from a closed position to the open position. In this way, the spring 478 can exert a force 486 on the shuttle 474 and the cam 472 to translate the securement arm 408 to the open position. In this way, the hinge assembly 410 can be a bi-stable hinge. As discussed above, the bi-stable hinge can provide feedback while the securement arm 408 is opening and/or closing and stabilize the arm 408 in either position. The bi-stable hinge can further create stability when the securement arm 408 is in an open or closed position such that securement arm 408 can translate from the open to closed position or closed to open position when a force exceeding a threshold is applied to the securement arm 408 by a user.

Any of the features, components, and/or parts, of the electronic device, including the arrangements and configurations thereof shown in FIG. 4A-FIG. 4B, can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 4A-FIG. 4B.

To the extent applicable to the present technology, gathering and use of data available from various sources can be used to improve the delivery to users of invitational content or any other content that may be of interest to them. The present disclosure contemplates that in some instances, this gathered data may include personal information data that uniquely identifies or can be used to contact or locate a specific person. Such personal information data can include demographic data, location-based data, telephone numbers, email addresses, TWITTER® ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to deliver targeted content that is of greater interest to the user. Accordingly, use of such personal information data enables users to calculated control of the delivered content. Further, other uses for personal information data that benefit the user are also contemplated by the present disclosure. For instance, health and fitness data may be used to provide insights into a user's general wellness or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services or anytime thereafter. In another example, users can select not to provide mood-associated data for targeted content delivery services. In yet another example, users can select to limit the length of time mood-associated data is maintained or entirely prohibit the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not intended to be exhaustive or to limit the embodiments to the precise forms disclosed. It will be apparent to one of ordinary skill in the art that many modifications and variations are possible in view of the above teachings.

What is claimed is:

1. A wearable electronic device, comprising:
a frame;
a display window coupled to the frame;
an arm extending from the frame; and
a compound hinge coupling the arm to the frame, the compound hinge including:
a first body coupled to the frame;
a second body articulatably coupled to the first body, the second body coupled to the arm;
a third body coupled to the first body and the second body;
a first hinge coupled to the first body, the arm configured to rotate relative to the frame about a first axis via the first hinge; and
a second hinge coupled to the second body, the arm configured to rotate relative to the frame about a second axis via the second hinge.

2. The wearable electronic device of claim 1, wherein the first body defines an internal volume.

3. The wearable electronic device of claim 1, wherein the third body comprises:
a protrusion configured to extend into the internal volume of the first body and contact the first hinge; and
an aperture defined by the third body.

4. The wearable electronic device of claim 3, wherein the first hinge comprises a spring hinge.

5. The wearable electronic device of claim 4, wherein:
the spring hinge comprises a spring coupled to the first body; and
the spring contacts the protrusion.

6. The wearable electronic device of claim 5, wherein the spring comprises a compression spring.

7. The wearable electronic device of claim 5, wherein the spring is configured to compress in response to a force on the protrusion from the arm moving relative to the frame about the first axis.

8. The wearable electronic device of claim 1, wherein the second hinge comprises a friction hinge.

9. The wearable electronic device of claim 8, wherein the friction hinge comprises:
a first washer in contact with the third body;
a second washer in contact with the first washer; and
a screw in contact with the second washer and disposed within the aperture of the third body.

10. The wearable electronic device of claim 9, wherein a rotation of the arm relative to the frame in the second axis is configured to increase a friction between the first washer and the second washer to position the arm relative to the frame.

11. A head-mountable device, comprising:
a frame defining a first internal volume;
a display window coupled to the frame;
an arm movably coupled to the frame, the arm defining a second internal volume; and
a hinge assembly, the hinge assembly comprising:
a first body within the first internal volume;
a second body within the second internal volume;
a spring coupled to the first body and the second body;
a third body coupled to the first body, the third body defining a first slot;
a fourth body coupled to the second body, the fourth body defining a second slot; and
a coupler in contact with the third body via the first slot and in contact with the fourth body via the second slot.

12. The head-mountable device of claim 11, wherein the second body defines a channel.

13. The head-mountable device of claim 12, further comprising a pin coupled to the first body, the pin articulatably coupled to the channel of the second body.

14. The head-mountable device of claim 13, wherein the channel guides the pin such that a pivot point of the arm relative to the frame is positioned outside the first internal volume and the second internal volume.

15. The head-mountable device of claim 11, wherein the coupler defines:
a first protrusion extending into the first slot; and
a second protrusion extending into the second slot.

16. The head-mountable device of claim 15, wherein:
the arm is configured to move relative to the frame via the hinge assembly; and
the coupler is configured to move relative to the first slot and the second slot as the arm moves relative to the frame.

17. The head-mountable device of claim 11, wherein the spring comprises a leaf spring.

18. A wearable device, comprising:
a frame defining a first internal volume;
a display window coupled to the frame;
a securement arm extending from the frame, the securement arm defining a second internal volume;
a hinge assembly, the hinge assembly comprising:
a cam disposed in the first internal volume; and
a shuttle disposed in the second internal volume, wherein a proximal end of the shuttle contacts the cam.

19. The wearable device of claim 17, wherein:
the cam defines a cam surface; and
a curvature of the cam surface defines a bi-stable hinge.

20. The wearable device of claim 17, wherein the shuttle comprises a spring.
